(19) United States
(12) Patent Application Publication
(10) Pub. No.: US 2010/0003157 A1
(43) Pub. Date: Jan. 7, 2010

(54) METALLIC POWDER MIXTURES

(75) Inventors: Roland Scholl, Gorwihl (DE); Ulf Waag, Sackingen (DE); Aloys Eiling, Bochum (DE)

Correspondence Address: CONNOLLY BOVE LODGE & HUTZ, LLP, P O BOX 2207, WILMINGTON, DE, 19899, US

(73) Assignee: H.C. Starck GmbH, Goslar (DE)

(21) Appl. No.: 12/373,324

(22) PCT Filed: Jul. 9, 2007
(86) PCT No.: PCT/EP07/56949

§ 371 Date: Mar. 11, 2009

(30) Foreign Application Priority Data
Jul. 12, 2006 (DE) 102006032561.3

(51) Int. Cl. B22F 3/10; B22F 3/02; B22F 3/18; C23C 4/08; B22F 1/00; B32B 15/02

(52) U.S. Cl. 419/23; 419/66; 419/69; 419/68; 427/456; 75/252; 75/230

(57) ABSTRACT

The invention relates to mixtures of metal, alloy or composite powders which have a mean particle diameter D50 of not more than 75 μm, preferably not more than 25 μm, and are produced in a process in which a starting powder is firstly deformed to give platelet-like particles and these are then comminuted in the presence of milling aids together with further additives and also the use of these powder mixtures and shaped articles produced therefrom.

The invention relates to mixtures of metal, alloy or composite powders which have a mean particle diameter D50 of not more than 75 μm, preferably not more than 25 μm, and are produced in a process in which a starting powder is firstly deformed to give platelet-like particles and these are then comminuted in the presence of milling aids together with further additives and also the use of these powder mixtures and shaped articles produced therefrom.

The patent application DE-A-103 31 785 discloses powders which can be obtained by a process for producing metal, alloy and composite powders having a mean particle diameter D50 of not more than 75 μm, preferably not more than 25 μm, determined by means of the particle measuring instrument Microtrac® X 100 in accordance with ASTM C 1070-01, from a starting powder having a larger mean particle diameter, wherein the particles of the starting powder are processed in a deformation step to give platelet-like particles whose ratio of particle diameter to particle thickness is from 10:1 to 10 000:1 and these platelet-like particles are subjected in a further process step to comminution milling or high-energy stress in the presence of a milling aid. This process is advantageously followed by a deagglomeration step. This deagglomeration step, in which the powder agglomerates are broken up into their primary particles, can be carried out, for example, in an opposed gas jet mill, an ultrasonic bath, a kneader or a rotor-stator apparatus. Such powders will be referred to as PZD powders in the present text.

Compared to conventional metal, alloy and/or composite powders which are used for powder-metallurgical applications, these PZD powders have various advantages such as improved green strength, pressability, sintering behaviour, widened temperature range for sintering and/or a lower sintering temperature and also higher strength, improved oxidation and corrosion behaviour of the shaped parts produced and lower production costs.

Disadvantages of these powders are, for example, poorer flowabilities. The altered shrinkage characteristics together with the lower packing density can lead to problems in powder-metallurgical processing as a result of greater sintering shrinkages. These properties of the powders are described in DE-A-103 31 785, which is hereby incorporated by reference.

Conventional powders which can be obtained, for example, by atomization of metal melts also have disadvantages. These are, in particular in the case of particular alloy compositions known as the high-alloy materials, lack of sintering activity, poor pressability and high production costs. These disadvantages have a reduced importance in, in particular, metal powder injection moulding (metal injection moulding, MIM for short), slip casting, wet powder spraying and thermal spraying. As a result of the poor green strength of conventional metal powders (in the sense of metal, alloy and composite powders, MAC for short), these materials are unsuitable for conventional powder-metallurgical pressing, for powder rolling and for cold isostatic pressing (CIP for short) with subsequent green machining, since the green bodies do not have sufficient strength for this.

It is an object of the present invention to provide metal powders for powder metallurgy which do not have the abovementioned disadvantages of conventional metal powders (MACs) and PZD powders but as far as possible combine their respective advantages such as high sintering activity, good pressability, high green strength and good pourability.

A further object of the present invention is to provide powders containing functional additives which can give the shaped articles produced from PZD powders characteristic properties, for example additives which increase the impact toughness or abrasion resistance, e.g. superhard powders, or additives which aid machining of the green bodies or additives which function as templates for controlling the pore structure.

A further object of the present invention is to provide high-alloy powders for the entire range of powder-metallurgical shaping processes, so that applications in fields which are inaccessible when using conventional metal, alloy or composite powders are also possible.

This object is achieved by metallic powder mixtures containing a component I, viz. a metal, alloy or composite powder which has a mean particle diameter D50 of not more than 75 μm, preferably not more than 25 μm, or from 25 μm to 75 μm, determined by means of the particle measuring instrument Microtrac® X 100 in accordance with ASTM C 1070-01, and can be obtained by a process in which the particles of a starting powder having a larger or smaller mean particle diameter are processed in a deformation step to give platelet-like particles whose ratio of particle diameter to particle thickness is in the range from 10:1 to 10 000:1 and these platelet-shaped particles are subjected in a further process step to comminution milling in the presence of a milling aid, a component II which is a conventional metal powder (MAC) for powder-metallurgical applications and a component III which is a conventional element powder. The steps of platelet production and comminution milling can be combined directly by carrying out the two steps directly in succession in one and the same apparatus under conditions which are matched to the respective objective (platelet production, comminution).

This object is additionally achieved by metallic powder mixtures containing a component I, viz. a metal, alloy or composite powder whose shrinkage determined by means of a dilatometer in accordance with DIN 51045-1 until the temperature of the first shrinkage maximum is reached is at least 1.05 times the shrinkage of a metal, alloy or composite powder having the same chemical composition and the same mean particle diameter D50 produced by means of atomization, with the powder to be examined being compacted to a pressed density of 50% of the theoretical density before measurement of the shrinkage, a component II which is a conventional metal powder (MAC) for powder-metallurgical applications and/or a component III which is a functional additive. If it is not possible to produce a handlable body having the desired density (50%) from conventional powders, higher densities are also permissible, for example as a result of the use of pressing aids. However, the density is in this case the same “metallic density” of the powder compacts and not the mean density of MAC powder and pressing aids.

Hard phases formed during comminution milling are immediately present in finely divided form in the powder produced. The phases formed (e.g. oxides, nitrides, carbides, borides) are therefore present in considerably finer and more homogeneous form in the component I than in the case of conventionally produced powders. This in turn leads to an increased sintering activity compared to phases of the same type which have been introduced in discrete form. This also improves the sinterability of the metallic powder mixture of the invention. Such powders having finely dispersed inclusions can be obtained, in particular, by targeted introduction of oxygen during the milling process and lead to formation of very finely divided oxides. Furthermore, it is possible to make targeted use of milling aids which are suitable as ODS particles and undergo mechanical homogenization and dispersion during the milling process.

The metallic powder mixture of the present invention is suitable for use in all powder-metallurgical shaping processes. Powder-metallurgical shaping processes are, for the purposes of the invention, pressing, sintering, slip casting, tape casting, wet powder spraying, powder rolling (cold, hot or warm powder rolling), hot pressing and hot isostatic pressing (HIP for short), sinter-HIP, sintering of powder beds, cold isostatic pressing (CIP), in particular with green machining, thermal spraying and deposited metal welding.

The use of the metallic powder mixtures in powder-metallurgical shaping processes leads to significant differences in processing and physical and materials properties and makes it possible to produce shaped articles which have improved properties even though the chemical composition is comparable with or identical to conventional metal powders.

Pure thermal spraying powders can also be used as repair solution for components. The use of pure agglomerated/sintered powders according to the as yet unpublished patent application DE-A-103 31 785 as thermal spraying powders allows the coating of components with a surface layer of the same type which has improved abrasion and corrosion behaviour compared to the base material. These properties result from very finely divided ceramic inclusions (oxides of the elements having the greatest affinity for oxygen) in the alloy matrix as a result of mechanical stress in the production of the powders according to DE-A-103 31 785.

Component I is an alloy powder which can be obtained by means of a two-stage process in which a starting powder is firstly deformed to give platelet-like particles and these are then comminuted in the presence of milling aids. In particular, the component I is a metal, alloy or composite powder which has a mean particle diameter D50 of not more than 75 μm, preferably not more than 25 μm, determined by means of the particle measuring instrument Microtrac® X 100 in accordance with ASTM C 1070-01, and can be obtained from a starting powder having a larger mean particle diameter particles having a smaller particle diameter, by a process in which the particles of the starting powder are processed in a deformation step to give platelet-like particles whose ratio of particle diameter to particle thickness is in the range from 10:1 to 10 000:1 and these platelet-like particles are subjected in a further process step to comminution milling in the presence of a milling aid.

The particle measuring instrument Microtrac® X 100 is commercially available from Honeywell, USA.

To determine the ratio of particle diameter to particle thickness, the particle diameter and the particle thickness are determined by means of optical microscopy. For this purpose, the platelet-like powder particles are firstly mixed with a viscous, transparent epoxy resin in a ratio of 2 parts by volume of resin to 1 part by volume of platelets. The air bubbles introduced during mixing are then driven out by evacuation of this mixture. The now bubble-free mixture is poured onto a flat substrate and subsequently rolled out by means of a roller. As a result, the platelet-like particles are preferentially aligned in the flow field between roller and substrate. The preferential direction is reflected in that the normals to the surface of the platelets are on average aligned parallel to the normals to the surface of the flat substrate, i.e. the platelets are on average arranged flat in layers on the substrate. After curing, specimens having suitable dimensions are cut from the epoxy resin plate located on the substrate. The specimens are examined under the microscope both perpendicular and parallel to the substrate. Using a microscope having calibrated optics and taking into account sufficient particle orientation, at least 50 particles are measured and a mean of these measured values is formed. This mean represents the particle diameter of the platelet-like particles. After making a perpendicular cut through the substrate and the specimen to be examined, the particle thicknesses are determined using the microscope having calibrated optics which was also used for determining the particle diameter. It should be ensured that only particles oriented as parallel as possible to the substrate are measured. Since the particles are surrounded on all sides by the transparent resin, it is not difficult to select suitably oriented particles and reliably assign the boundaries of the particles to be evaluated. Once again, at least 50 particles are measured and a mean of these measured values is formed. This mean represents the particle thickness of the platelet-like particles. The ratio of particle diameter to particle thickness is calculated from the parameters determined as described above.

This process makes it possible to produce, in particular, fine, ductile metal, alloy or composite powders. For the purposes of the present invention, ductile metal, alloy or composite powders are powders which, on application of mechanical stress to rupture, undergo plastic elongation or deformation before significant damage to the material (embrittlement of the material, rupture of the material) occurs. Such plastic changes in a material are materials-dependent and are in the range from 0.1 percent to a number of 100 percent, based on the initial length.

The degree of ductility, i.e. the ability of materials to deform plastically, i.e. permanently, under the action of mechanical stress can be determined or described by means of mechanical tensile and/or compressive testing.

To determine the degree of ductility by means of a mechanical tensile test, a tensile specimen is produced from the material to be evaluated. This can be, for example, a cylindrical specimen which in the middle region of the length has a reduction in the diameter by about 30-50% over a length of about 30-50% of the total specimen length. The tensile specimen is clamped into a clamping device of an electromechanical or electrohydraulic tensile testing machine. Before the actual mechanical test, strain gauges are installed in the middle of the specimen over a measurement length which is about 10% of the total specimen length. These strain gauges allow the increase in length in the selected measurement length to be monitored during application of a mechanical tensile stress. The stress is increased until rupture of the specimen occurs and the plastic proportion of the length change is evaluated with the aid of the recorded strain-stress curve. Materials which in such an arrangement display a plastic length change of at least 0.1% are referred to as ductile for the purposes of the present text.

In an analogous way, it is also possible to subject a cylindrical sample of material which has a ratio of diameter to thickness of about 3:1 to mechanical compressive stress in a commercial compressive testing machine. Here, application of a sufficient mechanical compressive stress likewise results in permanent deformation of the cylindrical specimen. After releasing the pressure and taking out the specimen, an increase in the ratio of diameter to thickness of the specimen is found. Materials which in such a test achieve a plastic change of at least 0.1% are likewise referred to as ductile for the purposes of the present text.

The process is preferably used to produce fine ductile alloy powders having a degree of ductility of at least 5%.

The ability of alloy or metal powders which in themselves cannot be comminuted further to be comminuted can be improved by use of mechanically, mechanochemically and/or chemically acting milling aids which are deliberately added or produced in the milling process. An important aspect of such a procedure is not to change or even influence the overall chemical “intended composition” of the powder produced in this way so as to improve the processing properties such as sintering behaviour or flowability.

The process is suitable for producing a wide variety of fine metal, alloy or composite powders having a mean particle diameter D50 of not more than 75 μm, preferably not more than 25 μm.

The metal, alloy or composite powders produced usually have a small mean particle diameter D50. The mean particle diameter D50 is preferably not more than 15 μm, determined in accordance with ASTM C 1070-01 (measuring instrument: Microtrac® X 100). To achieve an improvement in product properties in which fine alloy powders tend to be unfavourable (porous structures in which a particular materials thickness in the sintered state can withstand oxidation/corrosion better), it is also possible to set significantly higher 050 values (from 25 to 300 μm) than are usually desired while retaining the improved processing properties (pressing, sintering).

As starting powders, it is possible to use, for example, powders which already have the composition of the desired metal, alloy or composite powder. However, it is also possible to carry out the process using a mixture of a plurality of starting powders which give the desired composition only as a result of an appropriate choice of the mixing ratio. The composition of the metal, alloy or composite powder produced can also be influenced by the choice of the milling aid, if this remains in the product.

Powders having spherical or granular particles and a mean particle diameter D50 determined in accordance with ASTM C 1070-01 of usually greater than 75 μm, in particular greater than 25 μm, preferably from 30 to 2000 μm or from 30 to 1000 μm or from 75 μm to 2000 μm or from 75 μm to 1000 μm are preferably used as starting powders.

The starting powders required can, for example, be obtained by atomization of metal melts and, if necessary, subsequent sifting or sieving.

The starting powder is firstly subjected to a deformation step. The deformation step can be carried out in known apparatuses, for example in a roll mill, a Hametag mill, a high-energy mill or an attritor or stirred ball mill. As a result of appropriate selection of the process parameters, in particular the action of mechanical stresses which are sufficient to achieve plastic deformation of the material or the powder particles, the individual particles are deformed so that they finally have a platelet shape, with the thickness of the platelets preferably being from 1 to 20 μm. This can be effected, for example, by single loading in a roll mill or a hammer mill, by multiple stressing in “small” deformation steps, for example by impact milling in a Hametag mill or a Simoloyer®, or by a combination of impact and tribological milling, for example in an attritor or a ball mill. The high stressing of the material in this deformation leads to damage to the microstructure and/or embrittlement of the material which can be utilized in the subsequent steps for comminution of the material.

It is likewise possible to utilize melt-metallurgical rapid solidification processes for producing tapes or “flakes”. These are then, like the mechanically produced platelets, suitable for the comminution milling described below.

The apparatus in which the deformation step is carried out, the milling media and the other milling conditions are preferably selected so that the impurities caused by abrasion and/or reaction with oxygen or nitrogen are very low and are below the critical magnitude for use of the product or within the specification which the material has to meet.

This can be achieved, for example, by appropriate choice of the materials of the milling vessel and/or milling media and/or the use of gases which hinder oxidation and nitridation and/or the addition of protective solvents during the deformation step.

In a particular embodiment of the process, the platelet-like particles are produced in a rapid solidification step, e.g. by means of “melt spinning” directly from the melt by cooling on or between one or more preferably cooled rollers so that platelets (flakes) are formed directly.

The platelet-shaped particles obtained in the deformation step are subjected to comminution milling. Here, firstly, the ratio of particle diameter to particle thickness changes, generally giving primary particles (to be obtained after deagglomeration) having a ratio of particle diameter to particle thickness of from 1:1 to 100:1, advantageously from 1:1 to 10:1. Secondly, the desired mean particle diameter of not more than 75 μm, preferably not more than 25 μm, is set without difficult-to-comminute particle agglomerates being formed again.

The comminution milling can, for example, be carried out in a mill, for instance an eccentric vibratory mill but also in roller presses, extruders or similar apparatuses which break up the material in the platelet as a result of different speeds of motion and stressing rates.

The comminution milling is carried out in the presence of a milling aid. As milling aids, it is possible to use, for example, liquid milling aids, waxes and/or brittle powders. The milling aids can have a mechanical, chemical or mechanochemical action. If the metal powder is brittle enough, additions of further milling aids become superfluous; the metal powder is in this case effectively its own milling aid.

For example, the milling aid can be paraffin oil, paraffin wax, metal powder, alloy powder, metal sulphides, metal salts, salts of organic acids and/or urea powder.

Brittle powders or phases act as mechanical milling aids and can be used, for example, in the form of alloy, element, hard material, carbide, silicide, oxide, boride, nitride or salt powders. For example, use can be made of precomminuted element and/or alloy powders which together with the difficult-to-comminute starting powder used give the desired composition of the product powder.

As brittle powders, preference is given to using ones which comprise binary, ternary and/or higher compositions of the elements occurring in the starting alloy used, or else the starting alloy itself.

It is also possible to use liquid and/or readily deformable milling aids, for example waxes. Mention may be made by way of example of hydrocarbons such as hexane, alcohols, amines or aqueous media. These are preferably compounds which are required for the following steps of further processing and/or can easily be removed after comminution milling.

It is also possible to use specific organic compounds which are known from pigment production and are used there in order to stabilize nonagglomerating individual platelets in a liquid environment.

In a particular embodiment, use is made of milling aids which undergo a specific chemical reaction with the starting powder to promote milling and/or to set a particular chemical composition of the product. These can be, for example, decomposable chemical compounds of which only one or more constituents are required for setting the desired composition, with at least one component or one constituent being able to be largely removed by means of a thermal process.

It is also possible for the milling aid not to be added separately but instead to be produced in-situ during comminution milling. A possible procedure here is, for example, to produce the milling aid by addition of a reaction gas which reacts with the starting powder under the conditions of comminution milling to form a brittle phase. Preference is given to using hydrogen as reaction gas.

The brittle phases formed in the treatment with the reaction gas, for example as a result of formation of hydrides and/or oxides, can generally be removed again by means of appropriate process steps after comminution milling is complete or during processing of the resulting fine metal, alloy or composite powder.

If milling aids which are not removed or only partly removed from the metal, alloy or composite powder produced are used, these are preferably selected so that the constituents which remain influence a property of the material in a desired way, for example improve the mechanical properties, reduce the susceptibility to corrosion, increase the hardness and improve the abrasion behaviour or the frictional and sliding properties. An example which may be mentioned here is the use of a hard material whose proportion is increased in a subsequent step to such a degree that the hard material together with the alloy component can be processed further to give a cemented hard material or a hard material-alloy composite.

After the deformation step and the comminution milling, the primary particles of the metal, alloy or composite powders produced have a mean particle diameter D50 determined in accordance with ASTM C 1070-01 (Microtrac® X 100) of usually 25 μm, advantageously less than 75 μm, in particular less than or equal to 25 μm.

Owing to the known interactions between very fine particles, formation of coarser secondary particles (agglomerates) whose particle diameters are significantly above the desired mean particle diameter of not more than 25 μm can occur in addition to the desired formation of fine primary particles despite the use of milling aids.

The comminution milling is therefore preferably followed by a deagglomeration step, if the product to be produced does not allow or require (coarse) agglomerates, in which the agglomerates are broken up and the primary particles are liberated. The deagglomeration can, for example, be effected by application of shear forces in the form of mechanical and/or thermal stresses and/or by removal of separation layers previously introduced between primary particles in the process. The specific deagglomeration method to be employed depends on the degree of agglomeration, the intended use and the susceptibility to oxidation of the very fine powders and also the permissible impurities in the finished product.

The deagglomeration can, for example, be effected by mechanical methods, for instance by treatment in an opposed gas jet mill, sieving, sifting or treatment in an attritor, a kneader or a rotor-stator disperser. It is also possible to use a stress field as is produced in an ultrasonic treatment, a thermal treatment, for example dissolution or transformation of a previously introduced separation layer between the primary particles by means of cryogenic or high-temperature treatments, or chemical transformation of phases which have been introduced or deliberately produced.

The deagglomeration is preferably carried out in the presence of one or more liquids, dispersants and/or binders. In this way, a slip, a paste, a kneading composition or a suspension having a solids content of from 1 to 95% by weight can be obtained. In the case of solids contents in the range from 30 to 95% by weight, these can be processed directly by means of known powder-technological processes, for example injection moulding, tape casting, coating, hot casting, in order then to be converted into an end product in appropriate steps of drying, binder removal and sintering.

To carry out the deagglomeration of particularly oxygen-sensitive powders, preference is given to using an opposed gas jet mill which is operated under inert gases, for example argon or nitrogen.

Compared to conventional powders having the same mean particle diameter and the same chemical composition which had been produced, for example, by atomization, the metal, alloy or composite powders produced according to the invention display a series of particular properties.

The metal powders of component I display, for example, an excellent sintering behaviour. A lower sintering temperature usually suffices to achieve approximately the same sinter densities as in the case of powders produced by atomization. At the same sintering temperature, it is possible to achieve higher sinter densities starting out from powder compacts of the same pressed density, based on the metallic part of the pressed body. This increased sintering activity is also reflected, for example, in that the shrinkage to achieve the main shrinkage maximum of the powder of the invention during the sintering process is higher than in the case of conventionally produced powders and/or in that the (standardized) temperature at which the shrinkage maximum occurs is lower in the case of the PZD powder. In the case of uniaxially pressed bodies, different shrinkage curves can be obtained parallel and perpendicular to the pressing direction. In this case, the shrinkage curve is calculated by addition of the shrinkages at the respective temperature. Here, the shrinkage in the pressing direction contributes one third and the shrinkage perpendicular to pressing direction contributes two thirds of the shrinkage curve.

The metal powders of component I are metal powders whose shrinkage determined by means of a dilatometer in accordance with DIN 51045-1 up to the temperature of the first shrinkage maximum is at least 1.05 times the shrinkage of a metal, alloy or composite powder which has the same chemical composition and the same mean particle diameter D50 but has been produced by means of atomization, with the powder to be examined being compacted to a pressed density of 50% of the theoretical density before measurement of the shrinkage.

Furthermore, the metal powders of component I display a comparatively better pressing behaviour because of a particular particle morphology with a rough particle surface and a high pressed density because of a comparatively broad particle size distribution. This is reflected in that compacts of atomized powder have, at otherwise identical production conditions of the compacts, a lower flexural strength (known as green strength) than the compacts of PZD powders having the same chemical composition and the same mean particle size D50.

In addition, the sintering behaviour of powders of component I can be influenced in a targeted manner by the choice of the milling aid. Thus, one or more alloys which during heating form, because of their low melting point compared to the starting alloy, liquid phases which improve particle rearrangement and diffusion of material and thus improve the sintering behaviour or the shrinkage behaviour and therefore make it possible to achieve higher sintered densities at the same sintering temperature or the same sintered density at lower sintering temperatures, compared to the comparative powders, can be used as milling aids. It is also possible to use chemically decomposable compounds whose decomposition products form, together with the base material, liquid phases or phases which have an increased diffusion coefficient and promote densification.

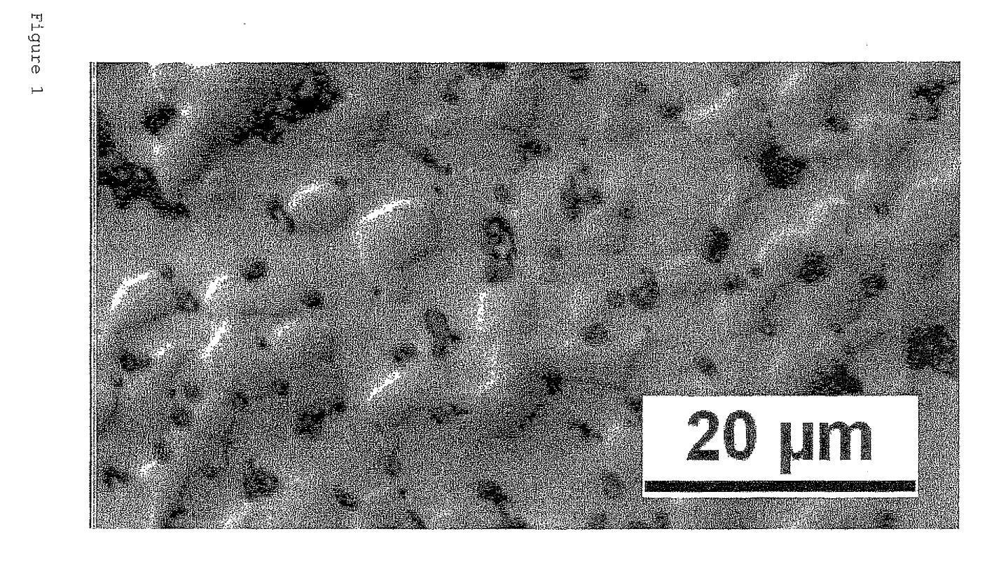

The components II of the metallic powder mixture according to the invention are conventional alloy powders for powder-metallurgical applications. These are powders which have an essentially spherical or granular shape of the particles, as depicted, for example, in FIG. 1 of DE-A-103 31 785. The chemical identity of the alloy powder is determined by an alloy of at least two metals. In addition, usual impurities can also be present. These powders are known to those skilled in the art and are commercially available. Numerous metallurgical or chemical processes for producing them are known. If fine powders are to be produced, the known processes frequently start with melting of a metal or an alloy. Coarse and fine mechanical comminution of metals or alloys is likewise frequently employed for producing “conventional powders”, but leads to a nonspherical morphology of the powder particles. Insofar as it works, this is a very simple and efficient method of producing powders. (W. Schatt, K.-P. Wieters in “Powder Metallurgy Processing and Materials”, EPMA European Powder Metallurgy Association, 1997, 5-10). The morphology of the particles is also decisively determined by the type of atomization.

If the melt is broken up by atomization, the powder particles are formed directly from the resulting droplets of melt by solidification. Depending on the type of cooling (treatment with air, inert gas, water), the process engineering parameters used, for instance the nozzle geometry, gas velocity, gas temperature or the nozzle material, and also materials parameters of the melt, e.g. melting point and solidification point, solidification behaviour, viscosity, chemical composition and reactivity with the process media, there are many possibilities but also restrictions of the process (W. Schatt, K.-P. Wieters in “Powder Metallurgy—Processing and Materials”, EPMA European Powder Metallurgy Association, 1997, 10-23).

Since powder production by means of atomization is of particular industrial and economic importance, various atomization concepts have become established. Particular processes are chosen according to the required powder properties, e.g. particle size, particle size distribution, particle morphology, impurities, and properties of the melts to be atomized, e.g. melting point or reactivity, and also the tolerable costs. However, there are often limits imposed by economic and technical considerations to the ability to achieve a particular property profile of the powders (particle size distributions, impurity contents, yield of “in-spec particles”, morphology, sintering activity, etc) at justifiable costs (W. Schatt, K.-P. Wieters in “Powder Metallurgy—Processing and Materials”, EPMA European Powder Metallurgy Association, 1997, 10-23).

The production of conventional alloy powders for powder-metallurgical applications by means of atomization has the particular disadvantage that large amounts of energy and atomization gas have to be used, which makes this procedure very costly. The production of, in particular, fine powder from high-melting alloys having a melting point of >1400° C. is not very economical because, firstly, the high melting point results in a very high energy input being needed to produce the melt and, secondly, the gas consumption increases greatly with decreasing desired particle size. In addition, there are often difficulties if at least one alloying element has a high affinity for oxygen. The use of specially developed nozzles enables cost advantages to be achieved in the production of particularly fine alloy powders.

Apart from the production of conventional alloy powders for powder-metallurgical applications by atomization, use is frequently also made of other single-stage melt-metallurgical processes such as “melt spinning”, i.e. the casting of a melt onto a cooled roller, which gives a thin tape which can generally not be readily comminuted, or “crucible melt extraction”, i.e. dipping of a cooled, profiled fast-rotating roller into a metal melt, which gives particles or fibres.

If cooling of the melt occurs in a relatively large volume/block, mechanical process steps such as coarse, fine and very fine comminution become necessary in order to produce alloy powders which can be processed by powder metallurgy. An overview of mechanical powder production is given by W. Schatt, K.-P. Wieters in “Powder Metallurgy Processing and Materials”, EPMA European Powder Metallurgy Association, 1997, 5-47.

Mechanical comminution, especially in mills, as the oldest method of particle size adjustment is very advantageous from an engineering point of view because it is not very complicated and can be applied to many materials. However, it makes particular demands of the material to be processed, for example in respect of the size of the pieces and brittleness of the material. In addition, comminution cannot be continued at will. Rather, a milling equilibrium which is the same as when the milling process starts out from finer powders is established. The conventional milling processes are then modified when the physical limits to the ability of the respective milled material to be comminuted have been reached and particular phenomena, for example embrittlement at low temperatures or the action of milling aids, no longer improve the milling behaviour or the ability to be comminuted. The conventional alloy powders for powder-metallurgical applications can be obtained by these abovementioned processes.

The components III of the metallic powder mixture of the invention are conventional element powders for powder-metallurgical applications. These are powders which have an essentially spherical, granular or fractal shape of the particles, as depicted, for example, in FIG. 1 of DE-A-103 31 785. These metal powders are element powders, i.e. these powders consist essentially of one, advantageously pure, metal. The powder can contain usual impurities. These powders are known to those skilled in the art and are commercially available. The production of these powders can be carried out in a manner analogous to the production of the alloy powders of component II, but in addition via reduction of oxide powders of the metal, so that the procedure (apart from the use of the starting metal) is identical. Numerous metallurgical or chemical processes for producing them are known. A possible production process is, purely by way of example, atomization as described, for example, in W. Schatt, K.-P. Wieters in “Powder Metallurgy Processing and Materials”, EPMA European Powder Metallurgy Association, 1997, 5-10. The morphology of the particles is also determined decisively by the type of atomization.

The production of conventional element powders for powder-metallurgical applications by means of atomization has the particular disadvantage that large amounts of energy and atomization gas have to be used, which makes this procedure very costly. The production of, in particular, fine powder from high-melting metals having a melting point of >1400° C. is not very economical because, firstly, the high melting point results in a very high energy input being needed to produce the melt and, secondly, the gas consumption increases greatly with decreasing desired particle size.

Apart from the production of conventional element powders for powder-metallurgical applications by atomization, use is frequently also made of other single-stage melt-metallurgical processes such as “melt spinning”, i.e. the casting of a melt onto a cooled roller, which gives a thin tape which can generally be readily comminuted, or “crucible melt extraction”, i.e. dipping of a cooled, profiled fast-rotating roller into a metal melt, which gives particles or fibres.

A further important variant of the production of conventional element powders for powder-metallurgical applications is the chemical route via reduction of metal oxides or metal salts (W. Schatt, K.-P. Wieters in “Powder Metallurgy—Processing and Materials”, EPMA European Powder Metallurgy Association, 1997, 23-30). Extremely fine particles which have particle sizes below one micron can also be produced by a combination of vaporization and condensation processes of metals and via gas-phase reactions (W. Schatt, K.-P. Wieters in “Powder Metallurgy—Processing and Materials”, EPMA European Powder Metallurgy Association, 1997, 39-41). These processes are technically very complicated.

The metallic powder mixture according to the invention contains

from 2% by weight to 100% by weight of component I which is an alloy containing from 5 to 60% by weight of chromium, from 0.5 to 5% by weight of silicon, from 0.1 to 3% by weight of carbon and cobalt to 100%;
from 0% by weight to 70% by weight of component II, viz. a conventional alloy powder which is an alloy containing from 55 to 60% by weight of chromium, from 0.5 to 5% by weight of silicon, from 0.1 to 3% by weight of carbon and cobalt to 100%;
from 20% by weight to 55% by weight of component III, viz. a conventional element powder composed of cobalt.

In a further embodiment of the invention, the metallic powder mixture according to the invention contains

from 20% by weight to 55% by weight of component I which is an alloy containing from 5 to 60% by weight of chromium, from 0.5 to 5% by weight of silicon, from 0.1 to 3% by weight of carbon and cobalt to 100%;
from 20% by weight to 55% by weight of component II, viz. a conventional alloy powder which is an alloy containing from 5 to 60% by weight of chromium, from 0.5 to 5% by weight of silicon, from 0.1 to 3% by weight of carbon and cobalt to 100%;
from 25% by weight to 50% by weight of component III, viz. a conventional element powder composed of cobalt.

The powder mixture according to the present invention can also contain, as component IV, from 0% by weight to 8% by weight of carbon, in particular from 0.5% by weight to 6% by weight.

The alloy which determines the chemical identity of the components I and II can advantageously be an alloy which contains the following alloy constituents:

from 5 to 20% by weight of chromium,
from 20 to 60% by weight of molybdenum,
from 1 to 5% by weight of silicon,
from 0.1 to 1% by weight of carbon,
to 100% by weight of cobalt.

The alloy which determines the chemical identity of the components I and II can advantageously be an alloy which contains the following alloy constituents

from 5 to 20% by weight of aluminum,
from 5 to 25% by weight of tantalum,
from 10 to 60% by weight of chromium,
from 0.5 to 3% by weight of silicon,
from 0.5 to 3% by weight of carbon,
from 0.5 to 3% by weight of yttrium,
to 100% by weight of cobalt.

In a further embodiment of the invention, a shaped article which is obtained by subjecting a metallic powder mixture according to the invention to a powder-metallurgical shaping process has a composition made up of the percentages of the sum of the components I to IV introduced. FIG. 1 shows the microstructure of a typical material in the polished section which has been produced from the metallic powder mixture according to the invention. The circular to oval pores (black in the image) which are distributed uniformly in the volume are characteristic. The size of the pores is typically in the range from 1 μm to 10 μm, advantageously from 1 μm to 5 μm.

In a further embodiment of the invention, the shaped article, the component I and/or the component II consist essentially of an alloy selected from the group consisting of Co9Cr29Mo2.5Si0.2C and Co25Cr7.5Al10Ta0.75Y0.75Si0.75C.

In a further embodiment of the invention, the powder mixture according to the invention contains additives which are largely or completely removed from the product and thus function as templates. These can be hydrocarbons or plastics. Suitable hydrocarbons are long-chain hydrocarbons such as low molecular weight, wax-like polyolefins, e.g. low molecular weight polyethylene or polypropylene, or else saturated, fully unsaturated or partially unsaturated hydrocarbons having from 10 to 50 carbon atoms or from 20 to 40 carbon atoms, waxes and paraffins. Suitable plastics are, in particular, those having a low ceiling temperature, in particular a ceiling temperature of less than 400° C. or below 300° C. or below 200° C. Above the ceiling temperature, plastics are thermodynamically unstable and tend to decompose into monomers (depolymerization). Suitable plastics are, for example, polyurethanes, polyacetals, polyacrylates and polymethacrylates or polystyrene. In a further embodiment of the invention, the plastic is used in the form of preferably foamed particles, for example foamed polystyrene spheres as are used as precursor or intermediate in the production of packaging materials or thermal insulation materials. Inorganic compounds which have a tendency to sublime can likewise function as place holders, for example some oxides of the refractory metals, in particular oxides of rhenium and molybdenum, and also partially or fully decomposable compounds, e.g. hydrides (Ti hydride, Mg hydride, Ta hydride), organic salts (metal stearates) or inorganic salts.

Addition of these additives which can be removed largely or completely from the product and thus function as templates makes it possible to produce components having a high density (from 90 to 100% of the theoretical density), slightly porous components (from 70 to 90% of the theoretical density) and highly porous components (from 5 to 70% of the theoretical density) by subjecting a metallic powder mixture according to the invention which contains such a functional additive as place holder to a powder-metallurgical shaping process.

The amount of additives which are largely or completely removed from the product and thus function as templates depends on the type and extent of the intended effect with which a person skilled in the art is in principle familiar, so that the optimal mixtures can be arrived at by means of a small number of experiments. When these compounds are used, the compounds used as place holders/templates have to be present in any structure suitable for their purpose in the metallic powder mixture, i.e. in the form of particles, as granules, powder, spherical particles or the like and with a sufficient size to achieve a template effect.

In general, the additives which are largely or completely removed from the product and thus function as templates are used in ratios of metal powder (sum of components I, II and III) to give additives, from 1:100 to 100:1 or from 1:10 to 10:1 or from 1:2 to 2:1 or 1:1.

It is also possible to add additives which alter the properties of the sintered body obtained from the powder mixture according to the invention. These are, for example, hard materials, for example oxides such as, in particular, aluminum oxide, zirconium oxide or yttrium oxide or carbides such as tungsten carbide, boron nitride or titanium nitride, which are advantageously used in amounts of from 100:1 to 1:100 or from 1:1 to 1:10 or from 1:2 to 1:7, or from 1:3 to 1:6.3 (ratio of the sum of components I, II and III:hard material).

In a further embodiment of the invention, the metallic powder mixture is a mixture of the sum of the components I, II and/or component III with hard material, with the proviso that the ratio is from 100:1 to 1:100 or from 1:1 to 1:10 or from 3:1 to 1:100 1:2 to 1:7 or from 1:3 to 1:6.3.

In a further embodiment of the invention, the metallic powder mixture is such a mixture with the proviso that the ratio is from 100:1 to 1:100 or from 1:1 to 1:10 or from 1:2 to 1:7 or from 1:3 to 1:6.3.

In a further embodiment of the invention, the metallic powder mixture is such a mixture with the proviso that when tungsten carbide is present as hard material, the ratio is from 100:1 to 1:100 or from 1:1 to 1:10 or from 1:2 to 1:7 or from 1:3 to 1:6.3.

As further additives, it is possible for additives which improve the processing properties such as the pressing behaviour, strength of the agglomerates, green strength or redispersibility of the powder mixture according to the invention to be present. These can be waxes such as polyethylene waxes or oxidized polyethylene waxes, ester waxes such as montanic esters, oleic esters, esters of linoleic acid or linolenic acid or mixtures thereof, paraffins, plastics, resins such as rosin, salts of long-chain organic acids, e.g. metal salts of montanic acid, oleic acid, linoleic acid or linolenic acid, metal stearates and metal palmitates, for example zinc stearate, in particular salts of the alkali and alkaline earth metals, for example magnesium stearate, sodium palmitate, calcium stearate, or lubricants. They are substances which are customary in powder processing (pressing, MIM, tape casting, slip casting) and are known to those skilled in the art. The compaction of the powder to be examined can be carried out using customary pressing aids such as paraffin wax or other waxes or salts of organic acids, e.g. zinc stearate. For example, reducible and/or decomposable compounds such as hydrides, oxides, sulphides, salts, sugars which are at least partially removed from the milled material in a subsequent processing step and/or during powder-metallurgical processing of the product powder and whose residues chemically supplement the powder composition in the desired way can also be mentioned.

The further additives which can improve the processing properties such as the pressing behaviour, strength of the agglomerates, green strength or redispersibility of the powder mixture according to the invention can also be hydrocarbons or plastics. Suitable hydrocarbons are long-chain hydrocarbons such as low molecular weight, wax-like polyolefins, low molecular weight polyethylene or polypropylene, and also saturated, fully unsaturated or partially unsaturated hydrocarbons having from 10 to 50 carbon atoms or from 20 to 40 carbon atoms, waxes and paraffins. Suitable plastics are, in particular, those having a low ceiling temperature, in particular a ceiling temperature of less than 400° C. or below 300° C. or below 200° C. Above the ceiling temperature, plastics are thermodynamically unstable and tend to decompose into monomers (depolymerization). Suitable plastics are, for example, polyurethanes, polyacetal, polyacrylates and polymethacrylates or polystyrene. These hydrocarbons or plastics are, in particular, suitable for improving the green strength of shaped bodies which are obtained from the powder mixtures according to the invention.

Suitable plastics are also described in W. Schatt, K.-P. Wieters in “Powder Metallurgy—Processing and Materials”, EPMA European Powder Metallurgy Association, 1997, 49-51, which is hereby incorporated by reference.

The following examples serve to illustrate the invention and aid understanding of the invention but do not constitute a restriction of the invention.

### EXAMPLES

The mean particle diameters D50 reported in the examples were determined by means of a Microtrac® X 100 from Honeywell/US in accordance with ASTM C 1070-01.

### Example 1

### Powder-Metallurgical Cobalt Alloy “T400”

A powder having a D50 of 53 μm is produced by water atomization of a metal melt having the composition: Co, 41.6%; Cr, 12.9%; Mo, 41.6%; Si, 3.6%; and C, 0.3%; (Table 1).

Sieving gives 2 fractions. Fraction 1: −106 μm/+35 μm and fraction 2: 0-35 μm.

Fraction 1 is processed as described in DE-A-103 31 785 to give a fine powder. The powder has a D50 of 15 μm. The powder produced in this way corresponds to the component I in the above description. 348 g are used in the mixture.

348 g of fraction 2 (component II) having a D50 of 20 μm were likewise introduced into the mixture.

As component III, use is made of a fine cobalt powder which has been produced by reduction of a Co oxide under hydrogen at 750° C. The powder has a D50 of 8 μm. Component III is added in an amount of 434 g to the mixture.

To improve the pressing behaviour, 1.3% of paraffin (<200 μm) are added to the powder mixture and the mixture is mixed by mixing for 10 minutes in a planetary ball mill (at a rotational speed of 120 rpm, 50% filled with balls, 10 mm steel balls).

As comparative example, a fully alloyed water-atomized powder of the target composition: Co, 59.6%; Cr, 9%; Mo, 29%; Si, 2.5%; and C, 0.2%; having a D50 of about 20 μm was admixed in an analogous manner with paraffin and processed to produce pressed shaped bodies.

Test specimens in accordance with DIN ISO 3995 “green strength specimen” were produced by uniaxial pressing in accordance with DIN/ISO 3995 on a hydraulic press at a pressure of 600 MPa. These were examined to determine their green density and green strength. The green density of the shaped bodies was determined from the volume (30 mm×12 mm×12 mm) and the mass (weighing by means of a microbalance, resolution: 0.1 mg) of the specimen. The green density is the ratio of mass to volume. The density of the sintered specimens is determined in the same way, but the specimens are ground flat on all sides before the length measurement. The green strength is determined in accordance with DIN/ISO 3995 by 3-point bending tests.

The two test specimens are then subjected to binder removal in a single pass under hydrogen in a tube furnace (heating to 600° C. at 2 K/min) and sintered immediately afterwards (heating at 10 K/mm to 1250° C., 1285° C. and 1300° C.). The sintering temperature was maintained for one hour. The specimens were then cooled to room temperature at an average cooling rate of 5 K/min.

The specimens obtained were examined in respect of sintered density.

It follows from the results that the variant according to the invention has advantages in respect of green strength and sintered density. Disadvantages are obtained in respect of the green density. The sintered density attains 95% of TD at only 1250° C. The high green strength is particularly relevant since it makes powder-metallurgical processing possible.

TABLE 1

| | | | | | | | | Proportion in | |
|---|---|---|---|---|---|---|---|---|---|
| | Elements | | | | | | | the mixture | |
| | Ni | Fe | Co | Cr | Mo | Si | C | g | % |
| Intended | 0 | 0 | 59.3 | 9 | 29 | 2.5 | 0.2 | | |
| proportion | | | | | | | | | |
| in the final | | | | | | | | | |
| alloy | | | | | | | | | |
| Actual | 0 | 0 | 41.6 | 12.9 | 41.6 | 3.6 | 0.3 | 100 | 69.7 |
| proportion in | | | | | | | | | |
| the master | | | | | | | | | |
| alloy for T400 | | | | | | | | | |
| Co addition | | | 43.5 | | | | | 43.5 | 30.3 |
| Sum | 0 | 0 | 85.1 | 12.9 | 41.6 | 3.6 | 0.29 | 144 | 100 |
| Composition of | 0 | 0 | 59.3 | 9 | 29 | 2.5 | 0.2 | | |
| the mixture/% | | | | | | | | | |

TABLE 2

| | GD | GS |
|---|---|---|
| Des. | % of TD | MPa |
| KL-WA | 75 | 2 |
| SA | 65 | 9 |

TABLE 3

| | SD (% TD) | SD (% TD) | SD (% TD) |
|---|---|---|---|
| Des. | 1250° C. | 1285° C. | 1300° C. |
| KL-WA | 86 | 92 | molten |
| SA | 89 | 96 | molten |

Legends:
GD green density of the pressed body
GS green strength of the pressed body
SD sintered density in % of the theoretical density

1-16. (canceled)

17. A metallic powder mixture comprising
from 2% by weight to 100% by weight of component I
wherein component I is an alloy comprising
from 55 to 60% by weight of chromium,
from 0.5 to 5% by weight of silicon,
from 0.1 to 3% by weight of carbon and
cobalt;
from 0% by weight to 70% by weight of component II,
wherein component II is an alloy powder which comprises an alloy comprising
from 5 to 60% by weight of chromium,
from 0.5 to 5% by weight of silicon,
from 0.1 to 3% by weight of carbon and
cobalt;
from 20% by weight to 55% by weight of component III,
wherein component III comprises element powder comprising
cobalt,
wherein component I is an alloy powder having a mean particle diameter D50 of not more than 75 μm, determined by means of the particle measuring instrument Microtrac® X 100 in accordance with ASTM C 1070-01, and can be obtained by a process in which the particles of a starting powder having a larger or smaller mean particle diameter are processed in a deformation step to give platelet-like particles whose ratio of particle diameter to particle thickness is in the range from 10:1 to 10 000:1 and these platelet-shaped particles are subjected in a further process step to comminution milling in the presence of a milling aid, component II is a conventional alloy powder for powder-metallurgical applications and component III is a conventional cobalt powder.

18. A metallic powder mixture comprising
from 2% by weight to 100% by weight of component I
wherein component I is an alloy comprising
from 5 to 60% by weight of chromium,
from 0.5 to 5% by weight of silicon,
from 0.1 to 3% by weight of carbon and
cobalt;
from 0% by weight to 70% by weight of component II,
wherein component II is an alloy powder which comprises an alloy comprising
from 5 to 60% by weight of chromium,
from 0.5 to 5% by weight of silicon,
from 0.1 to 3% by weight of carbon and
cobalt;
from 20% by weight to 55% by weight of component III,
wherein component III comprises element powder comprising
cobalt,
wherein component I is an alloy powder whose shrinkage determined by means of a dilatometer in accordance with DIN 51045-1 until the temperature of the first shrinkage maximum is reached is at least 1.05 times the shrinkage of an alloy powder having the same chemical composition and the same mean particle diameter D50 produced by means of atomization, with the powder to be examined being compacted to a pressed density of 50% of the theoretical density before measurement of the shrinkage.

19. The metallic powder mixture according to claim 17, wherein the component I is present in an amount of from 20 to 55% by weight, component II is present in an amount of from 20 to 55% by weight and component III is present in an amount of from 25 to 50% by weight.

20. The metallic powder mixture according to claim 17, wherein the components I and II contain the alloy constituents
from 5 to 20% by weight of aluminum,
from 5 to 25% by weight of tantalum,
from 10 to 60% by weight of chromium,
from 0.5 to 3% by weight of silicon,
from 0.5 to 3% by weight of carbon,
from 0.5 to 3% by weight of yttrium,
to 100% by weight of cobalt.

21. The metallic powder mixture according to claim 17, wherein the components I and II contain the alloy constituents
from 5 to 20% by weight of chromium,
from 20 to 60% by weight of molybdenum,
from 1 to 5% by weight of silicon,
from 0.1 to 1% by weight of carbon,
to 100% by weight of cobalt.

22. The metallic powder mixture according to claim 17, wherein the powder mixture additionally contains not more than 8% by weight of carbon as component IV.

23. The metallic powder mixture according to claim 17, wherein components I, II and III together correspond to a composition selected from the group consisting of Co9Cr29Mo2.5Si0.2C and Co25Cr7.5Al10Ta0.75Y0.75Si0.75C.

24. The metallic powder mixture according to claim 17, which further comprises a processing aid or a pressing aid.

25. The metallic powder mixture according to claim 17, which further comprises a hard material, a plastic, a hydrocarbon, a wax, a salt of long-chain organic acid or lubricant.

26. The metallic powder mixture according to claim 17, which further comprises a long-chain hydrocarbon, wax, paraffin, plastic, completely decomposable hydride, refractory metal oxide, organic salt or inorganic salt.

27. The metallic powder mixture according to claim 17, which further comprises a low molecular weight polyethylene or polypropylene, polyurethane, polyacetal, polyacrylate, polystyrene, rhenium oxide, molybdenum oxide, titanium hydride, or magnesium hydride/tantalum hydride.

28. A process for producing a shaped article which comprises subjecting the metallic powder mixture according to claim 17 to a powder-metallurgical shaping process.

29. The process according to claim 28, wherein the powder-metallurgical shaping process is selected from the group consisting of pressing, sintering, slip casting, tape casting, wet powder spraying, powder rolling (cold, hot or warm powder rolling), hot pressing and hot isostatic pressing (HIP), sinter-HIP, sintering of powder beds, cold isostatic pressing (CIP), in particular with green machining, thermal spraying and deposited metal welding.

30. A shaped article which can be obtained by a process according to claim 28.

31. A shaped article which comprises the powder mixture according to claim 17.

32. A shaped article obtained from the powder mixture according to claim 17, which has a composition selected from the group consisting of Co9Cr29Mo2.5Si0.2C and Co25Cr7.5Al10Ta0.75Y0.75Si0.75C.

33. The metallic powder mixture according to claim 17, wherein component I is an alloy powder having a mean particle diameter D50 of not more than 25 μm.

34. The metallic powder mixture according to claim 18, wherein the alloy which determines the chemical identity of the components I and II is an alloy which contains the following alloy constituents:
from 5 to 20% by weight of chromium,
from 20 to 60% by weight of molybdenum,
from 1 to 5% by weight of silicon,
from 0.1 to 1% by weight of carbon,
to 100% by weight of cobalt.

35. The metallic powder mixture according to claim 18, wherein the alloy which determines the chemical identity of the components I and II is an alloy which contains the following alloy constituents:
from 5 to 20% by weight of aluminum,
from 5 to 25% by weight of tantalum,
from 10 to 60% by weight of chromium,
from 0.5 to 3% by weight of silicon,
from 0.5 to 3% by weight of carbon,
from 0.5 to 3% by weight of yttrium,
to 100% by weight of cobalt.
